(19) United States
(12) Patent Application Publication
(10) Pub. No.: US 2008/0254805 A1
(43) Pub. Date: Oct. 16, 2008

(54) METHOD AND SYSTEM FOR MANAGING COMMUNICATION SESSION

(75) Inventor: Dalei GU, Singapore (SG)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/734,921

(22) Filed: Apr. 13, 2007

(51) Int. Cl. H04Q 7/38

(52) U.S. Cl. 455/445

(57) ABSTRACT

A method and system for managing a communication session is provided. The method includes receiving (304) a call setup request from a calling communication device, to establish the communication session with a called communication device. Further, the method includes determining (306) whether the calling communication device and the called communication device are registered with the UNC (200). Moreover the method includes providing (308) address information of the calling communication device to the called communication device and address information of the called communication device to the calling communication device. The calling communication device and the called communication device are registered with the UNC (200). Additionally, the method includes establishing (310) the communication session between the calling communication device and the called communication device. This communication session is established, based on the address information of the calling communication device and the address information of the called communication device.

### FIELD OF THE INVENTION

The present invention relates generally to the field of communication networks. More specifically, the present invention relates to a method and system for managing a communication session in a communication network.

### BACKGROUND OF THE INVENTION

The increased need for communication has greatly enhanced the role played by communication networks. Some examples of communication networks include Local Area Networks (LANs), Metropolitan Area Networks (MANs), Wide Area Networks (WANs), ad-hoc networks, the Internet, Public Switched Telephone Networks (PSTNs) and peer-to-peer networks. Communication networks facilitate communication among communication devices. Some examples of such communication devices include computers, mobile phones, laptops and Personal Digital Assistants (PDAs). These communication devices can be configured to operate in specific communication networks. For example, an Unlicensed Mobile Access (UMA)-enabled communication device can be configured to operate in the UMA communication network.

In a UMA communication network, the traffic from the UMA devices is routed via a UMA Network Controller (UNC) and a media gateway. A media gateway is present between two communication networks that have incompatible communication formats. The media gateway performs the task of translating communication traffic from one communication network into a communication format that is compatible with another communication network. The UNC handles all communication sessions that take place in the UMA communication network when both the communication devices are in the network. Since all the communication sessions in the UMA communication network are handled by the UNC, traffic load on the UNC increases.

Therefore, a need exists for a method and system for managing communication sessions without overloading the UNC.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates a communication network where various embodiments of the present invention can be practiced;

FIG. 2 illustrates a block diagram of an Unlicensed Mobile Access Network Controller (UNC), in accordance with an embodiment of the present invention;

FIG. 3 is a flow diagram illustrating a method for managing a communication session, in accordance with an embodiment of the present invention;

FIGS. 4 and 5 are flow diagrams illustrating a method for managing a communication session, in accordance with another embodiment of the present invention; and

FIG. 6 illustrates a message flow diagram for establishing a communication session among communication devices.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for managing a communication session, in accordance with various embodiments of the present invention, it should be observed that the present invention resides primarily in combinations of method steps related to the method and system for managing a communication session. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms ‘comprises,’ ‘comprising,’ or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by ‘comprises . . . a’ does not, without more constraints, preclude the existence of additional identical elements in the process, method, article or apparatus that comprises the element. The term ‘another,’ as used in this document, is defined as at least a second or more. The term ‘includes’, as used herein, is defined as comprising.

For an embodiment, a method for managing a communication session between a calling communication device and a called communication device in a communication network is provided. The method at an Unlicensed Mobile Access Network Controller (UNC) includes receiving a call request from the calling communication device, to establish the communication session with the called communication device. Further, the method includes determining whether the calling communication device and the called communication device are registered with the UNC. The method also includes providing address information of the calling communication device to the called communication device and address information of the called communication device to the calling communication device when the called communication device and the calling communication device are both registered with the UNC. Furthermore, the method includes establishing the communication session between the calling communication device and the called communication device. The communication session is established, based on the information relating to the addresses of the calling communication device and the called communication device.

For another embodiment, an Unlicensed Mobile Access Network Controller (UNC) is provided. The UNC includes a receiver. This receiver is configured to receive a call request from a calling communication device, to establish a communication session with a called communication device. The UNC also includes a processor. This processor is configured to determine the registration of the calling communication device and the called communication device with the UNC. The UNC also includes a transmitter. This transmitter is configured to transmit address information of the calling communication device to the called communication device when the calling communication device and the called communication device are registered with the UNC. The transmitter is also configured to transmit address information of the called communication device to the calling communication device when the calling communication device and the called communication device are registered with the UNC.

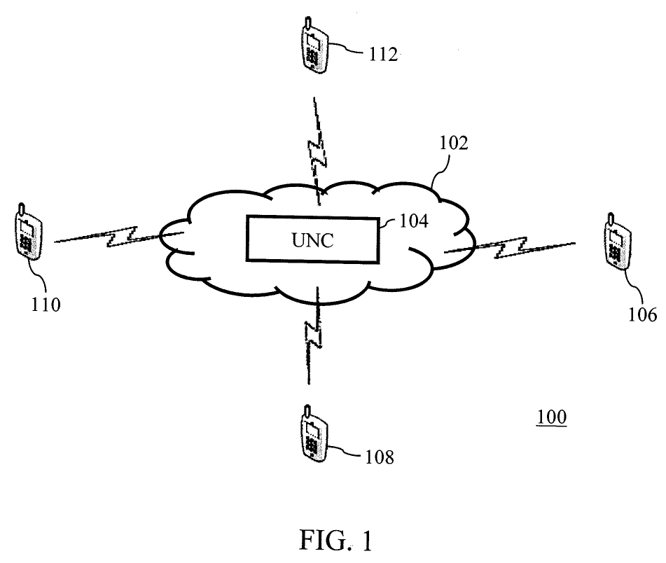

FIG. 1 illustrates a communication network 100 where various embodiments of the present invention can be practiced. The communication network 100 includes an unlicensed communication network 102. Examples of the unlicensed communication network 102 include a Bluetooth® network and a Wireless Fidelity (WiFi) network. The unlicensed communication network 102 includes a UMA Network Controller (UNC) 104, a communication device 106, a communication device 108, a communication device 110, and a communication device 112. The communication devices 106, 108, 110 and 112 are UMA-enabled communication devices. Examples of UMA-enabled communication devices include, but are not limited to, WiFi-enabled dual-mode mobile phones (GSM and UMA), Bluetooth-enabled UMA terminal adaptors, and UMA-enabled Soft VoIP phones. For the purpose of this description, the communication devices 106, 108, 110 and 112 can either be calling communication devices or called communication devices. For the purpose of this description, the communication device 106 will be referred to as the calling communication device 106 and the communication device 108 as the called communication device 108. A communication session is established between the calling communication device 106 and the called communication device 108.

The UNC 104 manages the communication session between the communication devices 106, 108, 110 and 112. The UNC 104 can provide a link between the unlicensed communication network 102 and licensed communication networks. Examples of licensed communication networks include, but are not limited to, Public Switched Telephone Networks (PSTNs), Global System for Mobile (GSM) communications, Code Division Multiple Access (CDMA), and the like. The UNC 104 also communicates with a mobile switching center that is present in the licensed communication network, to establish the communication session with a communication device in the licensed communication network. In an embodiment, the calling communication device 106 and the called communication device 108 can be present in the unlicensed communication network 102. In this embodiment, the UNC 104 directly establishes the communication session between the calling communication device 106 and the called communication device 108. After the call has been set up between the calling communication device 106 and the called communication device 108, voice traffic flows between them via the UNC 104. Although FIG. 1 is shown to include only the communication devices 106, 108, 110 and 112, it will be apparent to a person ordinarily skilled in the art that the communication network 100 can include more communication devices than shown in FIG. 1.

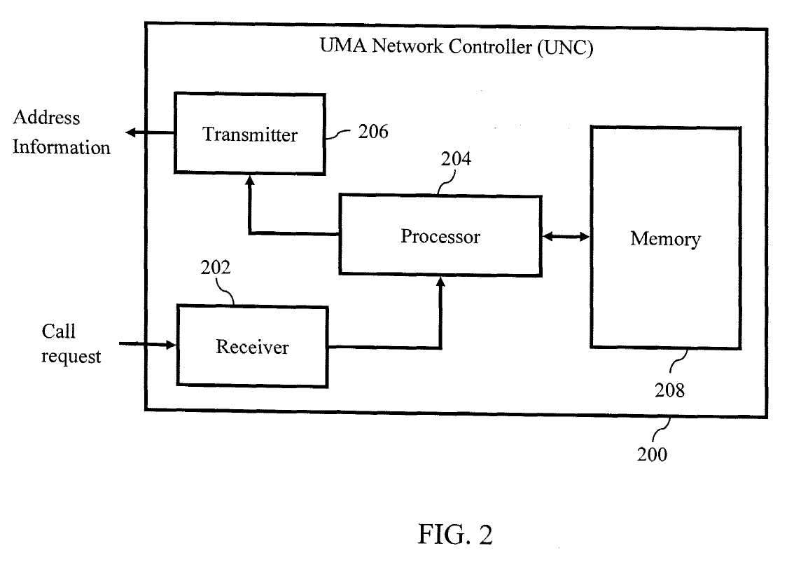

FIG. 2 illustrates a block diagram of a UNC 200, in accordance with an embodiment of the present invention. The UNC 200 includes a receiver 202, a processor 204 and a transmitter 206. In an embodiment, the UNC 200 also includes a memory unit 208. For the purpose of this description, the communication device 106 will be referred to as the calling communication device 106 and the communication device 110 as the called communication device 110.

The receiver 202 is configured to receive a call request from the calling communication device 106, to establish a communication session with the called communication device 110. The receiver 202 is also configured to communicate information received in the call request to the processor 204. Further, the receiver 202 can be configured to receive address information of the called communication device 110 and address information of the calling communication device 106 from a mobile switching center. The information pertaining to the address of the calling communication device 106 can include the IP address of the calling communication device 106, the port address of the calling communication device 106, and the like. Similarly, the information pertaining to the address of the called communication device 110 can include the IP address of the called communication device 110, the port address of the called communication device 110, and the like. The information pertaining to the addresses of the calling communication device 106 and the called communication device 110 are utilized to establish the communication session between the called communication device 110 and the calling communication device 106.

For establishing the communication session, the processor 204 determines the registration of the calling communication device 106, based on the information received by the receiver 202 in the call request. The processor 204 can also be configured to determine whether the called communication device 110 and the calling communication device 106 are registered with the UNC 200, based on information stored in the memory unit 208. After verifying the registration of the calling communication device 106 and the called communication device 110, the processor 204 retrieves information pertaining to the address of the calling communication device 106 from the memory unit 208. The processor 204 can also be configured to obtain information pertaining to the addresses of the called communication device 110 and the calling communication device 106 from a mobile switching center that is present in the unlicensed communication network 102. Further, the processor 204 can be configured to communicate the information relating to the addresses of the calling communication device 106 and the called communication device 110 to the transmitter 206.

The transmitter 206 is configured to transmit the call request from the calling communication device 106 to the mobile switching center, to establish a call with the called communication device 110. The transmitter 206 is also configured to transmit the information pertaining to the address of the calling communication device 106 to the called communication device 110. Further, the transmitter 206 is configured to transmit the information pertaining to the address of the called communication device 110 to the calling communication device 106 when the calling communication device 106 and the called communication device 110 are registered with the UNC 200 in the memory unit 208.

The memory unit 208 stores registration information of the communication devices present in the unlicensed communication network 102. In an embodiment, when a UMA-enabled communication device enters the coverage area of the unlicensed communication network 102, it is automatically registered with the UNC 200. The information relating to the registration is stored in the memory unit 208. The UMA-enabled communication device is present in and is capable of operating in the unlicensed communication network 102.

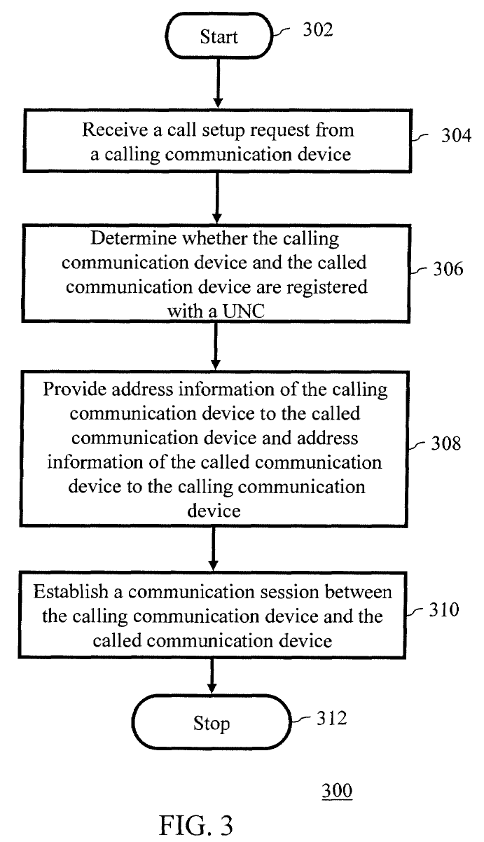

FIG. 3 is a flow diagram illustrating a method for managing a communication session 300, in accordance with an embodiment of the present invention. To describe the method 300, reference will be made to FIGS. 1 and 2, although it will be apparent to a person ordinarily skilled in the art that the method 300 can be implemented in any other suitable embodiment of the present invention.

At step 302, the method 300 is initiated at the UNC 200. For the purpose of this description, the communication device 108 will be referred to as the calling communication device 108 and the communication device 110 as the called communication device 110. At step 304, a call request is received from the calling communication device 108, to establish the communication session with the called communication device 110. After step 304, step 306 is performed.

At step 306, the UNC 200 determines whether the calling communication device 108 and the called communication device 110 are registered with the UNC 200. The memory unit 208 stores registration information of the UMA-enabled communication devices. The UNC 200 can verify that the calling communication device 108 and the called communication device 110 are both UMA-enabled by checking the information pertaining to the registration of the communication devices in the memory unit 208. The information pertaining to the registration of a communication device includes the unique device identity of the communication device, information relating to the address of the communication device, and the like. After step 306, step 308 is performed.

At step 308, the UNC 200 provides address information of the calling communication device 108 to the called communication device 110 and address information of the called communication device 110 to the calling communication device 108. Examples of information pertaining to the addresses of the calling communication device 108 and the called communication device 110 include, but are not limited to, information relating to their IP and port addresses. After step 308, step 310 is performed.

At step 310, the communication session is established between the calling communication device 108 and the called communication device 110, based on the information pertaining to the addresses of the calling communication device 108 and the called communication device 110. The communication session is established by creating a direct voice communication channel between the calling communication device 108 and the called communication device 110, without the UNC 200 as a communication agent. The direct voice communication channel is created by utilizing the information pertaining to the addresses received by the calling communication device 108 and the called communication device 110. At step 312, the method 300 is terminated.

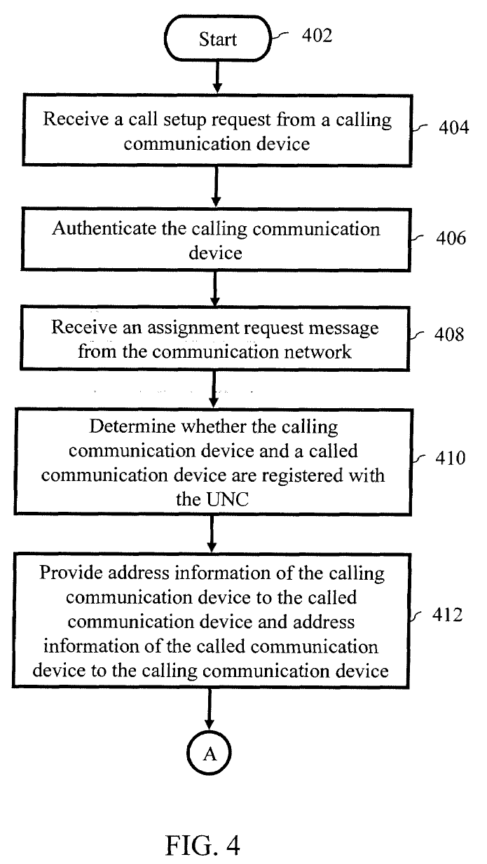

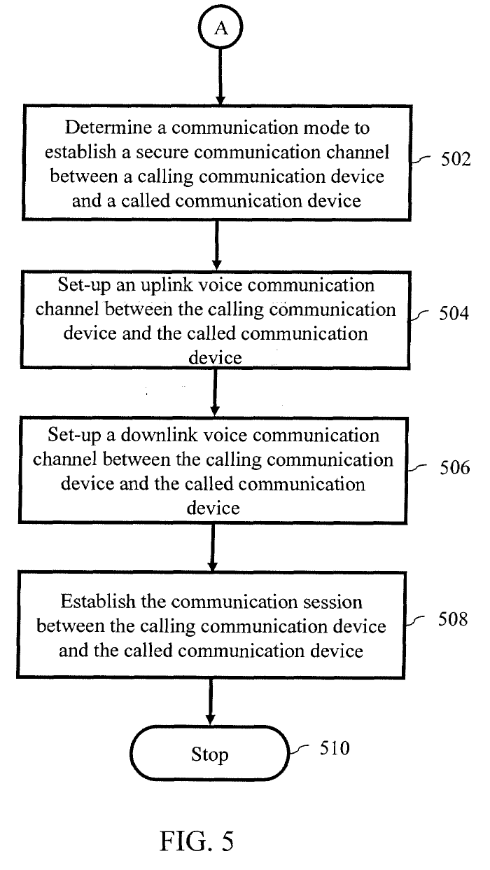

FIGS. 4 and 5 are flow diagrams illustrating a method for managing a communication session, in accordance with another embodiment of the present invention. To describe the method of the FIGS. 4 and 5, reference will be made to the FIGS. 1 and 2, although it should be understood that the method can be implemented by using any other suitable embodiment of the present invention. For the purpose of this description, the communication device 106 will be referred as the calling communication device 106 and the communication device 112 as the called communication device 112.

At step 402, the method for managing the communication session between the calling communication device and the called communication device in the unlicensed communication network 102 is initiated at the UNC 200.

At step 404, a call request is received from the calling communication device 106, to establish the communication session with the called communication device 112. The call request can include the device number of the called communication device 112. The called communication device 112 can be present in the unlicensed communication network 102 or in any other communication network.

At step 406, the UNC 200 authenticates the calling communication device 106 by using an Extensible Authentication Protocol-Subscriber Identity Module (EAP-SIM) mechanism or a public key mechanism.

In an embodiment, the UNC 200 forwards the call request to a mobile switching center that is present in the licensed communication network, to establish the communication session. The mobile switching center determines whether the called communication device 112 is present in the unlicensed communication network 102. On confirming the presence of the called communication device 112 in the unlicensed communication network 102, the mobile switching center responds to the call request sent by the calling communication device 106 with an assignment-request message.

At step 408, the UNC 200 receives an assignment-request message from the licensed communication network. This message is sent by the mobile switching center. The assignment-request message initiates a call setup procedure, in response to the call request sent by the calling communication device 106. The assignment-request message comprises information about the calling communication device 106 and the called communication device 112, which are required to set up a direct voice channel between the calling communication device 106 and the called communication device 112.

The UNC 200 sends an activate-channel request message to the calling communication device 106 and the called communication device 112 by using the information pertaining to the addresses of the calling communication device 106 and the called communication device 112. The activate-channel request message can include parameters such as the channel mode, the sample size of the payload, and the payload type. The channel mode refers to the mode of the communication channel to be established between the calling communication device 106 and the called communication device 112. Examples of the channel mode include, but are not limited to, a full-rate channel mode and a half-rate channel mode. The sample size of the payload refers to the minimum and/or maximum size of the payload that will be exchanged between the calling communication device 106 and the called communication device 112. Examples of the sample sizes of payloads can be 20 milliseconds, 40 milliseconds and 60 milliseconds. The payload-type parameter indicates the encoding scheme used for communication between the calling communication device 106 and the called communication device 112.

The UNC 200 receives an activate-channel acknowledgement message in response to the activate-channel request message sent to the calling communication device 106 and the called communication device 112. The UNC 200 receives an activate-channel acknowledgement message from the called communication device 112 and an activate-channel acknowledgement message from the calling communication device 106. The activate-channel acknowledgement message from the calling communication device 106 includes address information of the calling communication device 106. The activate-channel acknowledgement message from the called communication device 112 includes address information of the called communication device 112. The activate-channel acknowledgement message from a communication device includes information about the IP address of the communication device and information related to the Real Time Protocol User Datagram Protocol (RTP UDP) port address of the communication device.

At step 410, the UNC 200 determines whether the calling communication device 106 and the called communication device 112 are registered with the UNC 200. The UNC 200 utilizes the information relating to the addresses of the calling communication device 106 and the called communication device 112 received in the activate-channel acknowledgement message, to determine whether they are registered. The information pertaining to the registration of the UMA-enabled communication devices can be stored at the UNC 200. The UNC 200 verifies that the calling communication device 106 and the called communication device 112 are both UMA-enabled. The information pertaining to the registration of the calling communication device 106 and the called communication device 112 is available in a database present in the UNC 200. The information pertaining to the registration of a communication device includes the unique identity of the communication device, the information pertaining to the address of the communication device, and the like. The device identity is the phone number of the communication device, and the information relating to the address of the communication device includes, but is not limited to, the IP and port addresses of the communication device.

At step 412, the UNC 200 provides the information pertaining to the address of the calling communication device 106 to the called communication device 112, and the information relating to the address of the called communication device 112 to the calling communication device 106. The UNC 200 can provide the information pertaining to the address of the calling communication device 106 to the called communication device 112 via an activate-channel complete message. The UNC 200 can provide the information relating to the address of the called communication device 112 to the calling communication device 106 via an activate-channel complete message. The information pertaining to the address of the calling communication device can include the IP address of the calling communication device, the port address of the calling communication device, and the like. Similarly, the information pertaining to the address of the called communication device can include the IP address of the called communication device, the port address of the called communication device, and the like. However, it will be apparent to a person ordinarily skilled in the art that any information pertaining to an address, which uniquely identifies a communication device in the unlicensed communication network 102, can be used as information relating to the address.

At step 502, the UNC 200 determines a mode of communication between the calling communication device 106 and the called communication device 112, to establish a secure communication channel. Examples of secure communication modes include, but are not limited to, the Internet Protocol Security (IPsec) tunnel mode and the Secure Real Time Protocol (SRTP) mechanism.

At step 504, an uplink voice-communication channel is set up between the calling communication device 106 and the called communication device 112 via the UNC 200. The uplink voice-communication channel provides a communication channel for voice traffic to flow from the calling communication device 106 to the called communication device 112. The uplink voice-communication channel is set up, based on the information pertaining to the addresses of the called communication device 112 and the calling communication device 106.

At step 506, a downlink communication channel is set up between the calling communication device 106 and the called communication device 112 via the UNC 200. The downlink voice-communication channel provides a communication channel for voice traffic to flow from the calling communication device 106 to the called communication device 112. The downlink voice-communication channel is set up, based on the information pertaining to the addresses of the called communication device 112 and the calling communication device 106.

At step 508, the communication session is established between the calling communication device 106 and the called communication device 112, based on the information relating to the addresses of the calling communication device 106 and the called communication device 112. The calling communication device 106 and the called communication device 112 can utilize the information pertaining to the IP address and the port address that is received, to create a direct voice-communication channel. The information relating to the addresses of the calling communication device 106 and the called communication device 112 are utilized to create a UDP channel, to facilitate the flow of voice traffic between the calling communication device 106 and the called communication device 112. At step 510, the method is terminated.

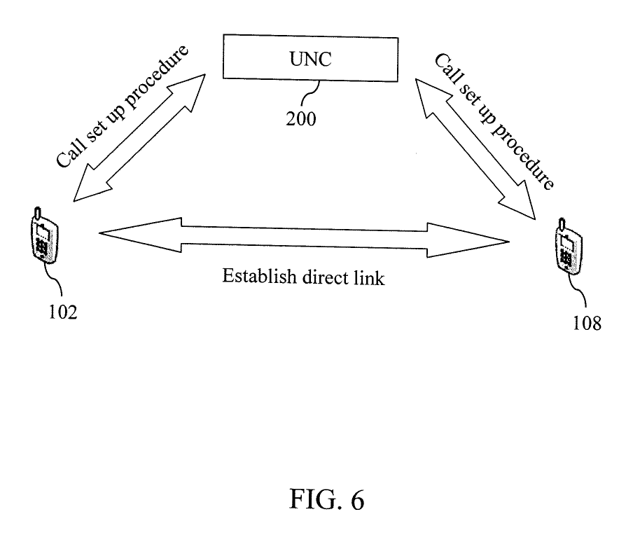

FIG. 6 illustrates a message flow diagram for establishing a communication session between communication devices. To describe the method for establishing the communication session, reference will be made to the FIGS. 1 and 2, although it should be understood that the method can be implemented in any other suitable embodiment of the present invention. The method will be explained in conjunction with the communication device 106 and the communication device 108. For the purpose of this description, the communication device 106 will be referred to as the calling communication device 106 and the called communication device 108 as the called communication device 108.

The UNC 200 verifies the presence of the calling communication device 106 and the called communication device 108. Thereafter, the UNC 200 communicates with the calling communication device 106 and the called communication device 108 individually, to obtain the information pertaining to the respective addresses of the calling communication device 106 and the called communication device 108. The UNC 200 sends this information to the called communication device 108 and the calling communication device 106 via activate-channel complete messages. The calling communication device 106 and the called communication device 108 utilize the information received to create an uplink voice-communication channel and a downlink voice-communication channel without the UNC 200 as a communication agent. A security mechanism is implemented to make the uplink voice-communication and downlink voice-communication channels secure. Examples of security mechanisms include, but are not limited to, the Internet Protocol Security (Ipsec) tunnel mode mechanism and the Secure Real Time Protocol (SRTP) mechanism. After the establishment of a voice channel between the calling communication device 106 and the called communication device 108, voice traffic flows directly between these devices.

Various embodiments, as described above, provide a method and system for managing a communication session between the communication devices present in an unlicensed communication network. The method uses an entity that is known as the Unlicensed Mobile Access Network Controller (UNC), which handles the task of establishing the communication session between the communication devices. The method also facilitates the management of the communication session between a calling communication device and a called communication device by directly setting up a voice-communication channel between the calling and called communication devices. Setting up the voice-communication channel directly results in a reduced load being placed on the UNC.

The UNC manages communication sessions between the communication devices present in the unlicensed communication network. Since the process of setting up a voice channel, as well as the task of handling all voice communication, is shifted to the calling communication device and the called communication device, the traffic load on the UNC is decreased. This results in better performance of the UNC, and enables it to handle a greater number of communication sessions. Moreover, since the voice traffic flows directly between the calling communication device and the called communication device, transport delay that was caused with the UNC as a mediator is reduced. Further, the appropriate security level is maintained by utilizing a security mechanism that is implemented by using either the Secure Real Time Protocol (SRTP) or the tunnel mode of Internet Protocol Security (Ipsec) architecture.

It will be appreciated that the method and system for managing a communication session in a communication network, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits and user-input devices. As such, these functions may be interpreted as steps of a method for managing a communication session in a communication network differently. Alternatively, some or all the functions can be implemented by a state machine that has no stored program instructions, or in one or more application-specific integrated circuits (ASICs), in which each function, or some combinations of certain of the functions, are implemented as custom logic. Of course, a combination of the two approaches can also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made, without departing from the scope of the present invention, as set forth in the claims below. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for managing a communication session between a calling communication device and a called communication device in a communication network, the method at an Unlicensed Mobile Access Network Controller (UNC) in the communication network comprising:
receiving a call request from the calling communication device to establish the communication session with the called communication device;
determining whether the calling communication device and the called communication device are registered with the UNC;
providing address information of the calling communication device to the called communication device and address information of the called communication device to the calling communication device when the calling communication device and the called communication device are registered with the UNC; and
establishing the communication session between the calling communication device and the called communication device based on the address information of the calling communication device and the address information of the called communication device.

2. The method as recited in claim 1 further comprising:
verifying registration of the calling communication device in a database; and
verifying registration of the called communication device in the database, wherein the database contains information of registered communication devices.

3. The method as recited in claim 1, wherein the calling communication device and the called communication device are UMA-enabled communication devices.

4. The method as recited in claim 1 further comprising authenticating the calling communication device.

5. The method as recited in claim 1 further comprising determining a communication mode to establish a secure communication channel between the calling communication device and the called communication device.

6. The method as recited in claim 1 further comprising setting up an uplink voice communication channel between the calling communication device and the called communication device.

7. The method as recited in claim 1 further comprising setting up a downlink voice communication channel between the calling communication device and the called communication device.

8. The method as recited in claim 1 further comprising receiving an assignment request message from the communication network, wherein the assignment request message comprises information of the calling communication device and the called communication device required to setup a voice channel.

9. The method as recited in claim 1 further comprising receiving an activate channel acknowledgement message from the calling communication device, wherein the activate channel acknowledgement message comprises the address information of the calling communication device.

10. The method as recited in claim 1 further comprising receiving an activate channel acknowledgement message from the called communication device; wherein the activate channel acknowledgement message comprises the address information of the called communication device.

11. The method as recited in claim 1 further comprising:
providing the address information of the called communication device to the calling communication device comprises sending an activate channel complete message to the calling communication device, wherein the activate channel complete message comprises the address information of the called communication device; and
providing the address information of the calling communication device to the called communication device comprises sending an activate channel complete message to the called communication device, wherein the activate channel complete message comprises the address information of the calling communication device.

12. The method as recited in claim 11 further comprising receiving an uplink voice communication channel from the calling communication device, wherein the uplink voice communication channel is setup by the calling communication device based on the address information of the called communication device.

13. The method as recited in claim 11 further comprising receiving a downlink voice communication channel from the calling communication device, wherein the downlink voice communication channel is setup based on the address information of the called communication device.

14. An Unlicensed Mobile Access Network Controller (UNC) comprising:
a receiver configured to receive a call request from a calling communication device to establish a communication session with a called communication device;
a processor configured to determine registration of the calling communication device and the called communication device with the UNC; and
a transmitter configured to:
transmit address information of the calling communication device to the called communication device when the calling communication device and the called communication device are registered with the UNC; and
transmit address information of the called communication device to the calling communication device when the calling communication device and the called communication device are registered with the UNC.

15. The UNC as recited in claim 14 further comprising a memory unit configured to store registration information of the calling communication device and the called communication device.

16. The UNC as recited in claim 14, wherein the receiver is further configured to receive the address information of the called communication device.

17. The UNC as recited in claim 14, wherein the receiver is further configured to receive the address information of the calling communication device.
